(19) United States
(12) Patent Application Publication
(10) Pub. No.: US 2023/0162244 A1
(43) Pub. Date: May 25, 2023

(54) ONLINE DONATION AND PAYMENT MANAGEMENT SYSTEM

(71) Applicant: Sylvia Weddington, Marietta, GA (US)

(72) Inventor: Sylvia Weddington, Marietta, GA (US)

(21) Appl. No.: 17/533,398

(22) Filed: Nov. 23, 2021

(51) Int. Cl. G06Q 30/02; G06Q 20/10; G06Q 20/32

(52) U.S. Cl. CPC G06Q 30/0279; G06Q 20/102; G06Q 20/3255

(57) ABSTRACT

An online donation and payment management system. The system includes at least one user-recipient client device, at least one user-donor client device, a network system, at least one database for storing user profile information, an enterprise management server, and a donation gateway engine. The enterprise management server having one or more computer programs, one or more processors and one or more computer-readable storage media. The server is configured to create a profile for a user-recipient and store the profile in the first database, assign a unique account number to the user-recipient, create a virtual donation account for the user-recipient, generate a table to link the user-recipient's unique account number to the virtual donation account created for the user-recipient, receive a donation request from the at least one user-recipient client device, via the network, create an electronic payment link corresponding to the donation request, and publish a donation petition corresponding to the donation request to a donation platform, wherein the donation petition includes the electronic payment link.

### FIELD OF THE INVENTION

Embodiments described herein generally relate to online management systems, and more particularly to online donation and payment management systems.

### BACKGROUND OF THE INVENTION

Since the widespread use of the internet, online payment systems have become common use. Most of the online payment systems are directly related to purchases and not donations. Using the internet to make online donations can be very beneficials to users, since the users may reach a large audience to draw donations from. Hence, an efficient online donation and payment management system is desirable.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably. The various advantages of the embodiments of the present disclosure will become apparent to one skilled in the art by reading the following specification and appended claims, and by referencing the following drawing(s), in which:

FIG. 1 depicts an illustrative architecture in which techniques and structures for providing the systems and methods disclosed herein may be implemented.

FIG. 2 shows a flow diagram illustrating by way of example the steps that may be performed by the illustrative architecture for online donation and payment management according to an embodiment of the of the present disclosure.

FIGS. 3A-3C show an exemplary view of user interfaces displayed on a client device according to an embodiment of the present disclosure.

### SUMMARY OF THE INVENTION

Exemplary embodiments disclosed herein describe an online donation and payment management system. The system includes at least one user-recipient client device, at least one user-donor client device, a network, at least one data storage device, an enterprise management server having one or more computer programs, one or more processors and one or more computer-readable storage media. The server is configured to create a profile for a user-recipient and store the profile in at least one database in the at least one data storage device, assign a unique account number to the user-recipient, create a virtual donation account for the user-recipient, generate a table in the at least one data storage device to link the user-recipient's unique account number to the virtual donation account created for the user-recipient, receive a donation request from the at least one user-recipient client device, via the network, create an electronic payment link corresponding to the donation request, wherein the electronic payment link allows a user-donor to make an online donation to a user-recipient's virtual donation account using a user-donor client device, and publish a donation petition corresponding to the donation request to a donation platform, wherein the donation petition includes the electronic payment link.

In some exemplary embodiments, the system includes a donation gateway engine comprising one or more computer programs, and one or more computer-readable storage, the donation gateway engine receives an incoming donation from a user-donor via the electronic payment link; determines a corresponding user-recipient's virtual donation account, and deposits the incoming donation in the user-recipient's virtual donation account.

In some exemplary embodiments, the donation platform includes at least one or more from the group comprising a web site, web application, cloud application, mobile application, and social media site.

In some exemplary embodiments, the electronic payment link is a shareable payment link.

In some exemplary embodiments, the electronic payment link includes a corresponding user-recipient's unique account number.

In some exemplary embodiments, the at least one user-recipient client device includes a graphical user interface for displaying one or more user interfaces.

In some exemplary embodiments, at least one of the user interfaces is a dashboard that displays a current total of a corresponding user-recipient's virtual donation account.

In some exemplary embodiments, at least one of the user interfaces allows a user-recipient to cash out its virtual donation account.

In some exemplary embodiments, a user-recipient may send the electronic payment link to a user-donor directly by email, text, social media, messaging or SMS.

In some exemplary embodiments, the user-donor may send a donation to a user-recipient via the electronic payment link on the donation platform.

In some exemplary embodiments, the user-donor may send a donation to a user-recipient using the electronic payment link sent directly to the user-donor from the user-recipient.

### DETAILED DESCRIPTION

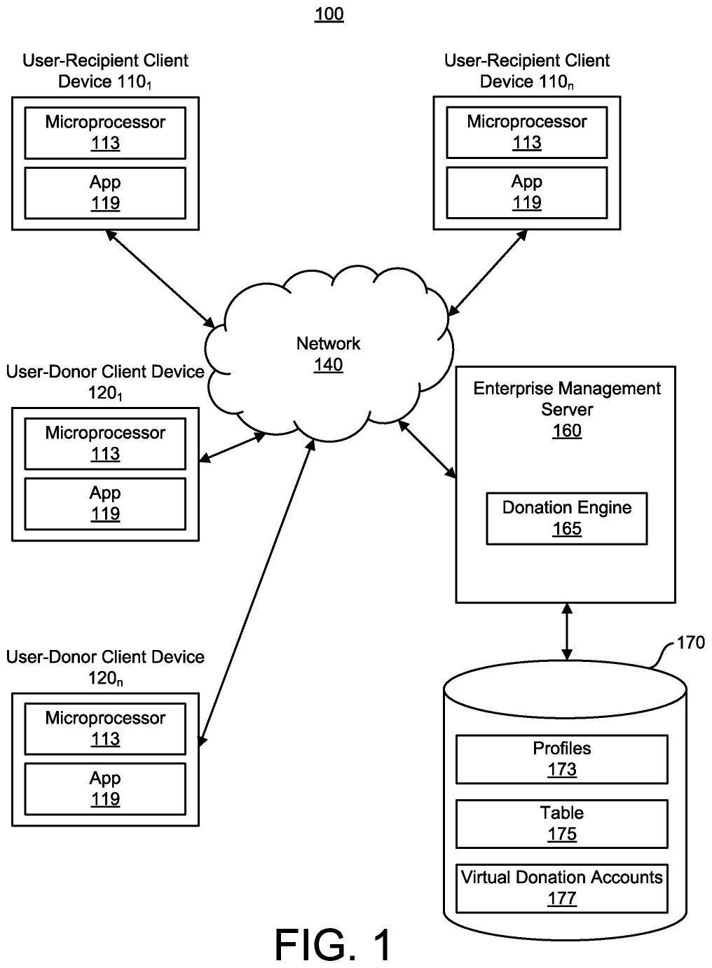

The disclosed embodiments describe an online donation and payment management system 100. The system allows a user to start a donation petition which is posted to a donation platform where it is visible to other users. Each donation petition includes an electronic payment link which may be used by donors to make a donation. Once the donation is reached, the user may cash out. Turning now to the drawings, FIG. 1 depicts an illustrative system architecture 100 in which techniques and structures of the present disclosure may be implemented. The illustrative architecture 100 may include at least one user-recipient client device 110, at least one user-donor client device 120, a network 140, and at least one enterprise management server 160. The enterprise management server 160 includes at least one data storage device 170 and a donation gateway engine 165. The user-recipient client device 110 and the user-donor client device 120 may be collectively referred to as client device (110, 120).

Although not shown, the system 100 includes one or more electronic communications channels for transmitting data between user-recipient client device 110, user-donor client device 120, network 140, and enterprise management server 160. While a limited number of client devices, networks, and enterprise management servers are illustrated, the system may include any number of client devices, networks, and enterprise management servers.

The network 140 may include any one or a combination of multiple different types of networks, such as cable networks, the Internet, wireless networks, and other private and/or public networks. In some instances, the network 140 may include cellular, Wi-Fi, or Wi-Fi direct. The network may be the Internet or any other suitable network for the transmitting of data from a source to a destination.

The at least one user-recipient client device 110 and the at least one user-donor client device 120 may include a mobile device, a tablet, a laptop device, and/or a personal desktop computer. The client device (i.e., the user-recipient client device 110 and the user-donor client device 120) is communicably coupled to network 140. It should be noted that other types of devices might be used with the present application. For example, a PDA, an MP3 player, or any other wireless device, a gaming device (such as a handheld system or home based system), any computer wearable device, and the like (including a P.C. or other wired device) that may transmit and receive information may be used with the present application. In a preferred embodiment, the client device is a smart phone.

The client device (110, 120) may execute a user browser to interface with network 140, an email application used to send and receive emails, a text application used to send and receive text messages, and many other types of applications. Communication may occur between the client device (110, 120) and the network 140 via applications (e.g., app 119) executing on said device (i.e., 110, 120) and the applications may be downloaded via an application store or may reside on the client device by default. Additionally, communication may occur on the client device using the client device's operating system to perform the logic to communicate without the use of applications.

The client device (110, 120) may include one or more computer-readable storage media, one or more processors (e.g., 113) and one or more computer programs (e.g., 119). One or more of the computer programs may include code that is used to execute a donation platform (e.g., application 119). The donation platform may include one or more processors and one or more computer programs. The donation platform may operate (i.e., run/execute) on a client device (110, 120) and the donation platform may include any one or more from the group comprising a web site, web browser, application programming interfaces, operating system, web application, cloud application, mobile application, and social media site. The donation platform allows a user-recipient to create a donation request. The donation request is sent to enterprise management server 160. Upon receipt of the donation request, the enterprise management server 160 will create a corresponding donation petition and post the donation petition to the donation platform. Anyone accessing the platform will be able to see pending donation petitions which have been posted to the platform.

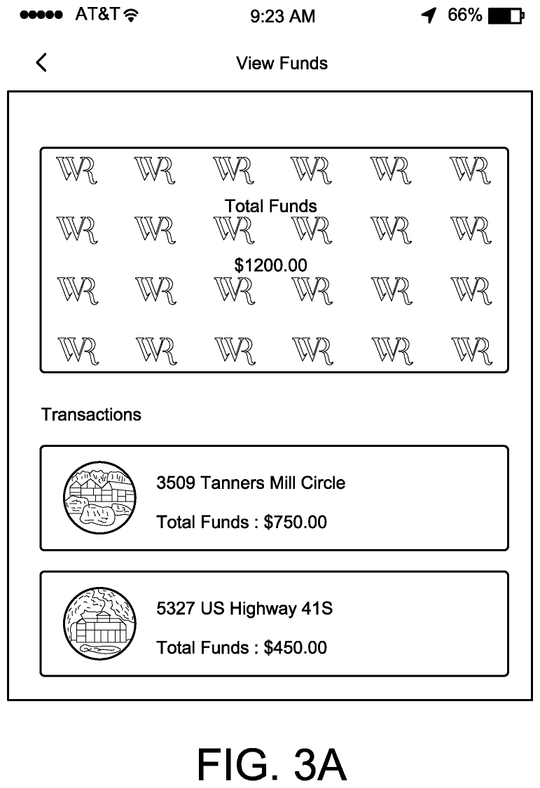

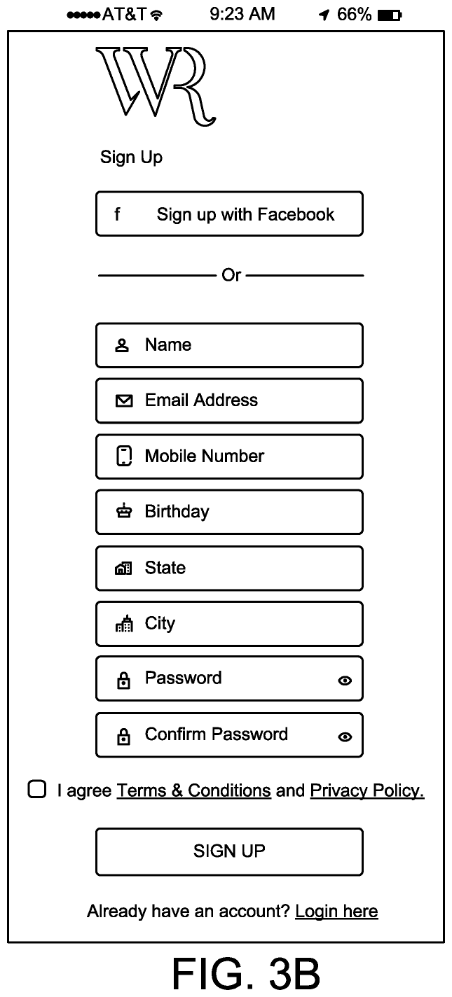

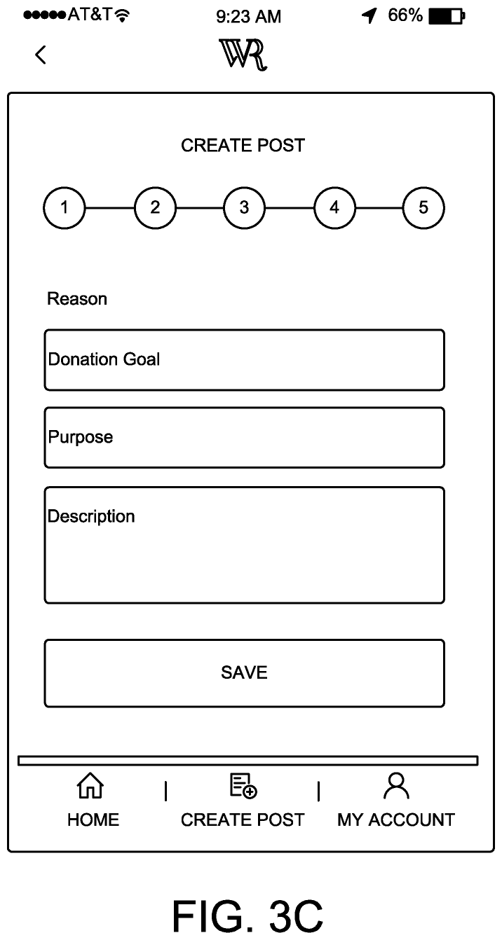

Client device (110, 120) include a graphical user interface for displaying one or more user interfaces. At least one of the one or more user interfaces is a dashboard that displays a current total of a corresponding user-recipient's donation account, as shown in FIG. 3A. A user interface may show a screen that the user-recipient may use to register an account to use the platform, as shown in FIG. 3B. A user interface may also show a screen that the user-recipient may use to request a donation/post a donation petition, as shown in FIG. 3C. In some of the embodiments, at least one of the user interfaces allows a user-recipient to cash out its donation account or to use the amount in the donation account to make a payment (e.g., to pay closing costs for a new home purchase).

Enterprise management server 160 includes one or more programs, one or more processors and one or more computer readable storage media, including at least one data storage device 170. The one or more computer programs are stored in the one or more computer-readable storage media. The one or more computer programs may comprise multiple hardware or software modules and contain program instructions that cause the one or more processors to perform various tasks, functions or features.

The at least one data storage device includes profile database 173, table 175, virtual donation account database 177, and a ledger account 179. The profile database 173 stores profile information for registered users. Table 175 lists all registered users and their corresponding unique account number. The table links each user's unique account number to the user's virtual donation account. The virtual donation account database stores account information (e.g., balance information) for a corresponding virtual donation account. The ledger account may include a table of all of the donation transactions received on the donation platform.

The enterprise management server 160 creates a profile for a user-recipient, stores the profile in database 173, creates a virtual donation account for the user-recipient, generates a table 175 to link the user-recipient's unique account number to the donation account created for the user-recipient, receive a donation request from the at least one user-recipient client device via the network, create an electronic payment link corresponding to the donation request, wherein the electronic payment link allows a user-donor to make an online donation to the user-recipient making the donation request using a user-donor client device and publishes a donation petition corresponding to the donation request to the donation platform.

The donation gateway engine 165 includes one or more computer-readable storage media, one or more processors and one or more computer programs. The one or more computer programs are stored in the one or more computer-readable storage media. The one or more computer programs may comprise multiple hardware or software modules and contain program instructions that cause the one or more processors to perform various tasks, functions or features.

The donation gateway engine may receive an incoming donation from a user-donor via the electronic payment link and thereafter, determine a corresponding user-recipient's virtual donation account using table 175. The one or more processors may search the table 175 for the unique account number included in the electronic payment link. If a matching entry is found, the corresponding virtual donation account linked to the unique account number is used by the donation gateway engine to register a deposit of the incoming donation in the corresponding virtual donation account.

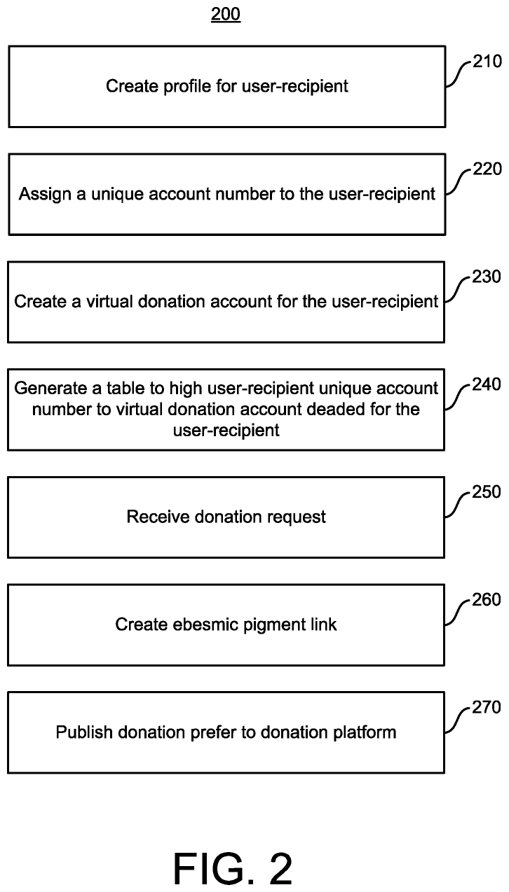

FIG. 2 shows an exemplary high level flow diagram 200 of a method for providing online donation and payment management according to an embodiment of the present disclosure.

In operation, a user may download application 119 from a server (e.g., enterprise management server 160) or a mobile app store. Once the user launches the application 119, the user is prompted to register to use the donation platform by creating an account. At step 210, the enterprise management server 160 creates a profile for the user using the information provided by the user. The profile may include identifying information for the user, such as, for example, the user's name, birthday, contact information, a username and password for accessing the platform, and banking information. The enterprise management server stores the user's profile in database 173 which is stored in the at least one data storage device 170.

A user accessing the donation platform to request donations is a user-recipient and the device used by the user-recipient to access the platform and send/receive data to/from the enterprise management server is a user-recipient client device. A user accessing the platform to provide donations is a user-donor and the device used by the user-donor to access the platform and send/receive data to/from the enterprise management server 160 is a user-donor client device. A user-recipient is required to register to use the donation platform to make a donation request. A user-donor is not required to register to use the donation platform to make a donation.

Once the profile is setup, at step 220, the enterprise management server 160 assigns a unique account number to the user (e.g., user-recipient) and at step 230, the enterprise management server 160 creates a virtual donation account for the user (e.g., user-recipient). The donation account is where the corresponding user's collected donations are stored. At step 240, the enterprise management server creates a table 175 which lists all registered users and their unique corresponding account number. The table links each user's unique account number to the user's virtual donation account. The table 175 may be stored in database 170. The unique account number will be used in an electronic payment link to direct incoming donations to the user-recipient's donation account.

The user-recipient's donation account may be linked to the user-recipient's bank account. In some aspects, the user-recipient's donation account may be linked to an admin bank account. The enterprise management server 160 collects all incoming donations. The server may store the donations in a central admin bank account, and each user-recipient's incoming donation may be retrieved from the central admin account and directed to the user-recipient's donation account. In some aspects, the server may store the incoming donations directly in the corresponding user-recipient's donation account.

At step 250, the enterprise management server 160 receives a donation request a user-recipient. Then the server 160, at step 260, creates an electronic payment link corresponding to the request. The electronic payment link is an online payment process where a request for online payment is generated and shared to user-donors to make instant online payments using, for example, a user-donor client device. The link directs user-donors to a landing page (i.e., webpage) where an online payment (i.e., donation) can be made. The landing page may display, for example, user-recipient information, and payment options, such as, for example, credit card, Apple Pay, Google Pay, etc. The electronic payment link may include the unique account number of the user-recipient making the donation request. In some embodiments, the donation payment may be made using a QR code. The electronic payment link is shareable and may be embedded in a post on the donation platform or shared directly to users via social media, messaging, short message service (SMS), email, text, etc.

After the enterprise management server 160 creates the electronic payment link, the server 160, at step 270, generates a donation petition (i.e., a message created for posting on the donation platform). The server publishes (i.e., posts on Internet) the donation petition to the donation platform. The server 160 may use a file transfer protocol (ftp) program to create a link between a client device and the server to post the donation petition to the hosting space for the donation platform, which essentially publishes the donation petition on the donation platform. The server 160 may post the donation petition to the donation platform using the ftp program. In some embodiments, the client device (110, 120) may post the donation petition to the donation platform using a ftp program.

After a donation petition has been published to the donation platform, the enterprise management server 160 may receive/collect incoming donations from user-donors via donation gateway engine 165. A user-donor may send a donation to a user-recipient by accessing the electronic payment link in the user-recipient's donation petition which is published on the donation platform. In some embodiments, a user-donor may send a donation to a user-recipient by accessing the electronic payment link sent directly to the user-donor via email, text, social media, messaging, or short message service (SMS). The user-donor may send the donation using the electronic payment link sent directly to the user-donor without accessing the donation platform.

The donation gateway engine 165 processes incoming donations received from user-donors. The donation gateway engine interfaces with a third party payment processing application to collect online payments. Thereafter, the donation gateway engine determines a corresponding user-recipient's virtual donation account using table 175 and deposits (i.e., registers a deposit) the incoming donation in the user-recipient's virtual donation account.

The computer programs contain program instructions that are converted to executable code. The executable code is committed to memory using machine codes selected from the specific machine language instruction set, or native instructions, designed into the hardware microprocessor. The hardware microprocessor is configured to perform a predefined set of logic operations in response to receiving a corresponding basic instruction selected from a predefined native instruction set of machine codes. Each native instruction is a discrete code that is recognized by the hardware microprocessor and that can specify particular registers for arithmetic, addressing, or control functions; particular memory locations or offsets; and particular addressing modes used to interpret operands. The program instructions are a set of machine codes that are selected from the native instruction set that are processed by the hardware microprocessor.

The present disclosure may be described in the general context of computer code or machine-useable instructions, including computer-executable instructions such as program modules, being executed by a computer or other machine, such as a personal data assistant or other handheld device. Generally, program modules include routines, programs, objects, components, data structures, etc., and refer to code that perform particular tasks or implement particular abstract data types. The present disclosed system 100 may be practiced in a variety of system configurations, including hand-held devices, consumer electronics, more specialty computing devices, etc. The present disclosed system may also be practiced in distributed computing environments where tasks are performed by remote-processing devices that are linked through a communications network.

Computer-readable storage media include volatile and nonvolatile, removable and non-removable media implemented in any method or technology for storage of information such as computer-readable instructions, data structures, program modules or other data. Computer-readable storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the any of the one or more processors. Computer storage media excludes signals per se.

Memory generally includes computer-readable storage media in the form of volatile and/or nonvolatile memory. The memory may be removable, non-removable, or a combination thereof. Exemplary hardware devices include solid-state memory, hard drives, optical-disc drives, etc. Processor is a hardware computing device and generally includes central processing unit, microprocessor, graphics processing unit, digital signal processor, application-specific instruction set processor (ASIP), machine-learning processor—a specialized microprocessor designed specifically for processing machine learning models, physics processing unit (PPU), image processor, coprocessor, floating-point unit, network processor, etc.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

The disclosed embodiments are not inclusive and many other modifications and variations will be apparent to someone of ordinary skill in the art with construction skills in the related arts. Further, the steps of the disclosed methods can be modified in various manners, including by reordering steps, executing multiple steps concurrently, and/or inserting or deleting steps, without departing from the principles of the invention. Together the descriptions and accompanying illustrations seek to provide an explanation of the basic principles of the embodiment and its application. It is therefore intended that the specification and embodiments be considered as exemplary only.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An online donation and payment management system, the system comprising:
at least one user-recipient client device;
at least one user-donor client device;
a network;
at least one data storage device;
an enterprise management server having one or more computer programs, one or more processors and one or more computer-readable storage media, the server configured to:
create a profile for a user-recipient and store the profile in at least one database in the at least one data storage device;
assign a unique account number to the user-recipient;
create a donation account for the user-recipient;
generate a table in the at least one data storage device to link the user-recipient's unique account number to the donation account created for the user-recipient;
receive a donation request from the at least one user-recipient client device via the network;
create an electronic payment link corresponding to the donation request, wherein the electronic payment link allows a user-donor to make an online donation to the user-recipient making the donation request using a user-donor client device; and
publish a donation petition corresponding to the donation request to a donation platform, wherein the donation petition includes the electronic payment link.

2. The system of claim, further comprising:
a donation gateway engine comprising one or more computer programs, and one or more computer-readable storage, the donation gateway engine is configured to:
receive an incoming donation from a user-donor via the electronic payment link;
determine a corresponding user-recipient's virtual donation account using the table; and
deposit the incoming donation to the user-recipient's donation account.

3. The system of claim 1, wherein the donation platform includes at least one or more from the group comprising a web site, web application, cloud application, mobile application, and social media site.

4. The system of claim 1, wherein the electronic payment link is a shareable payment link.

5. The system of claim 1, wherein the electronic payment link includes a corresponding user-recipient's unique account number.

6. The system of claim 1, wherein the at least one user-recipient client device incudes a graphical user interface for displaying one or more user interfaces.

7. The system of claim 6, wherein at least one of the user interfaces is a dashboard that displays a current total of a corresponding user-recipient's donation account.

8. The system of claim 6, wherein at least one of the user interfaces allows a user-recipient to cash out its donation account.

9. The system of claim 1, wherein a user-recipient may send the electronic payment link to a user-donor directly by email, text, social media, messaging, SMS.

10. The system of claim 1, wherein the user-donor may send a donation to a user-recipient via the electronic payment link on the donation platform.

11. The system of claim 9, wherein the user-donor may send a donation to a user-recipient using the electronic payment link sent directly to the user-donor from the user-recipient.
